(19) United States
(12) Patent Application Publication
(10) Pub. No.: US 2014/0050085 A1
(43) Pub. Date: Feb. 20, 2014

(54) OBJECT-TO-OBJECT INTELLIGENT NETWORK (O2N) COMMUNICATION SYSTEM PROVIDING MULTIPLE TRANSMISSION CHANNELS, AND OPERATING METHOD OF SAID SYSTEM

(71) Applicant: Electronics and Telecommunications Research Institute, Daejeon (KR)

(72) Inventors: Yong Geun HONG, Daejeon (KR); Hyoung Jun KIM, Daejeon (KR)

(21) Appl. No.: 13/916,448

(22) Filed: Jun. 12, 2013

(30) Foreign Application Priority Data
Aug. 14, 2012 (KR) 10-2012-0089108

(51) Int. Cl. H04L 12/911

(52) U.S. Cl. CPC H04L 47/821
USPC 370/230

(57) ABSTRACT

Provided is an object-to-object intelligent network (O2N) communication system in which machine to machine (M2M) access networks are configured to include a plurality of networks for connecting an M2M device and an M2M server, the M2M device provides the M2M server with transmission channel information, the M2M server provides the M2M device with requirement information, and an urgency of a service, based on the transmission channel information, thereby enabling a transmission channel corresponding to service information to be selected, identifier information of a packet generated by the M2M server is extracted, a transmission channel is selected from among the M2M access networks based on the extracted identifier information, a priority table reflecting transmission information, the transmission channel information, and the requirement information of the M2M access networks are provided, and a network is selected by referring to the priority table.

### CROSS-REFERENCE TO RELATED APPLICATION

This application claims the benefit of Korean Patent Application No. 10-2012-0089108, filed on Aug. 14, 2012, in the Korean Intellectual Property Office, the disclosure of which is incorporated herein by reference.

### BACKGROUND

1. Field of the Invention

The present invention relates to an object-to-object intelligent network (O2N) communication system, and more particularly, to an O2N communication system providing multiple transmission channels in which machine to machine (M2M) access networks may be configured to include a plurality of networks for connecting an M2M device and an M2M server, the M2M device may provide the M2M server with transmission channel information including an error rate, a data rate, and cost information for each channel of a network being connected, the M2M server may provide the M2M device with requirement information corresponding to a cost, an error rate, and a volume of service data, and an urgency of a service, based on the transmission channel information, thereby enabling a transmission channel corresponding to service information to be selected, identifier information of a packet generated by the M2M device or the M2M server may be extracted, a transmission channel may be selected from among the M2M access networks based on the extracted identifier information, a priority table reflecting transmission information including an error rate, a data rate for each service, the transmission channel information, and the requirement information of the M2M access networks may be provided, and a network may be selected by referring to the priority table.

2. Description of the Related Art

An object-to-object intelligent network (O2N) communication, also referred to as machine to machine (M2M) communication or machine type communication (MTC), is a technology for providing information service readily, by exchanging information between devices absent user manipulation.

In a related art, FIG. 1 illustrates KR Patent Application Publication No. 10-2012-0016572, titled “Device in Wireless Network, Device Resource Management Apparatus, Gateway, Network Server, and Control Method of the Network Server”. KR 10-2012-0016572 relates to a device having free mobility and varied usage, and an apparatus and method for providing various wireless interfaces independent of a type of device. KR 10-2012-0016572 is directed to a device resource management apparatus in a wireless network, the device resource management apparatus including an access mode selection module to select a predetermined access mode among a plurality of access modes for a device, each of the plurality of access modes determining a type of a medium included in an access route between the device and an opponent device, and a device agency module to obtain an agent profile corresponding to the device when an access route between the device and the opponent device is formed based on the predetermined access mode, and to perform, as a proxy for the device, at least one function defined by the agent profile. However, KR 10-2012-0016572 is limited to management of device resources and thus, the performance may be fluctuated greatly with a state of a wireless interface.

In another related art, FIG. 2 illustrates KR Patent Publication No. 10-1048854, titled “Service Control Method and System of M2M Application for User Traffic Data”. KR 10-1048854 is directed to a system for controlling a service with respect to subscriber traffic data of an M2M application, the system including an M2M module to verify recognition information corresponding to a type of a device to be selectively connected and tendency information of the M2M application executed by the device, and to transfer the verified information to an M2M control server, and the M2M control server to control the transmitted and received subscriber traffic data not to exceed a restricted range, based on quality of service (QoS) reference information of a subscriber that is verified based on the tendency information of the M2M application received from the M2M module. However, since KR 10-1048854 is configured to verify the QoS reference information of the subscriber based on the tendency information of the M2M application, and to restrict the subscriber traffic data based on the verified QoS reference information, there may be restrictions on a service corresponding to an urgency or a volume of information requested by the subscriber.

In still another related art, FIG. 3 illustrates KR Patent Publication No. 10-0998753, titled “M2M Module for Noticing a State of Emergency, M2M Device Selectively Connected with the M2M Module, and Driving Method Thereof”. KR 10-0998753 is directed to an M2M module including a control unit to verify a data format to be provided by an M2M device being connected, to transmit a request for an operation for obtaining emergency situation noticing information having the data format to the M2M device, and to receive the emergency situation noticing information from the M2M device, and a communication unit to transmit the obtained emergency situation noticing information obtained to a service server functioning for taking a necessary action based on the emergency situation noticing information. However, KR 10-0998753 may not achieve an expected efficiency in use since a cost and whether information is to be provided to the service server may be determined based on an error rate, a transmission rate, and a connection state between the M2M module and the service server.

### SUMMARY

In order to resolve the foregoing issues of the related arts, an aspect of the present invention provides an object-to-object intelligent network (O2N) communication system providing multiple transmission channels and an operating method of the system that may configure machine to machine (M2M) access networks to include a plurality of networks for connecting an M2M device and an M2M server.

Another aspect of the present invention also provides an O2N communication system providing multiple transmission channels and an operating method of the system in which an M2M device may provide an M2M server with transmission channel information including an error rate, a data rate, and cost information for each channel of a network being connected, the M2M server may provide the M2M device with requirement information corresponding to a cost, an error rate, and a volume of service data, and an urgency of a service, based on the transmission channel information, and the M2M device may select a transmission channel for each piece of service information based on the requirement information.

Still another aspect of the present invention also provides an O2N communication system providing multiple transmission channels and an operating method of the system that may extract identifier information of a packet generated by an M2M server, and select a transmission channel from among M2M access networks based on the extracted identifier information.

Yet another aspect of the present invention also provides an O2N communication system providing multiple transmission channels and an operating method of the system that may provide a priority table reflecting transmission information including an error rate and a data rate for each service, transmission channel information, and requirement information of M2M access networks, and select a network by referring to the priority table.

According to an aspect of the present invention, there is provided an O2N communication system providing multiple transmission channels, the system including an M2M device to collect transmission channel information including information about network traffic, a data rate, and a connection state for each channel with respect to a plurality of networks of M2M access networks being connected, and to provide the collected transmission channel information to an M2M server, and the M2M server to transmit, to the M2M device, requirement information including a usage cost and a quality of service (QoS) for each piece of data desired to be serviced, based on the transmission channel information. Here, the M2M device may select one of a plurality of channels from among the M2M access networks, based on the transmitted requirement information, and may be provided with a data service through the selected channel.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a technology relating to a device in a wireless network, a device resource management apparatus, a gateway, a network server, and a control method of the network server according to a related art;

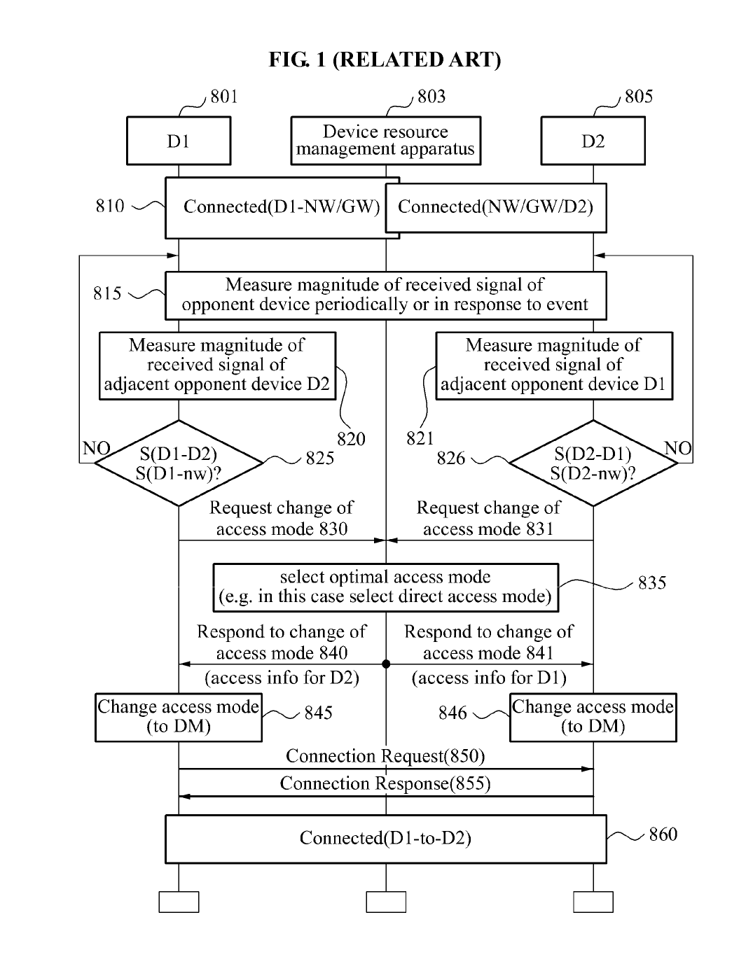

FIG. 2 is a diagram illustrating a technology relating to a service control method and a system of a machine to machine (M2M) application for user traffic data according to a related art;

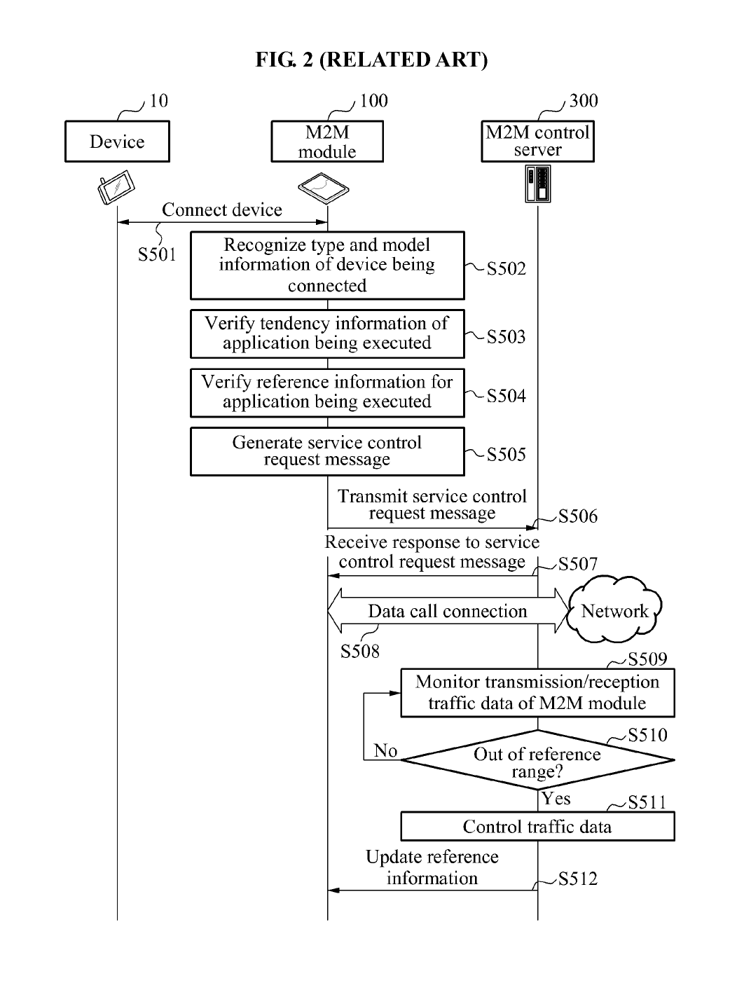

FIG. 3 is a diagram illustrating a technology relating to an M2M module for noticing a state of emergency, an M2M device selectively connected with the M2M module, and a driving method thereof according to a related art;

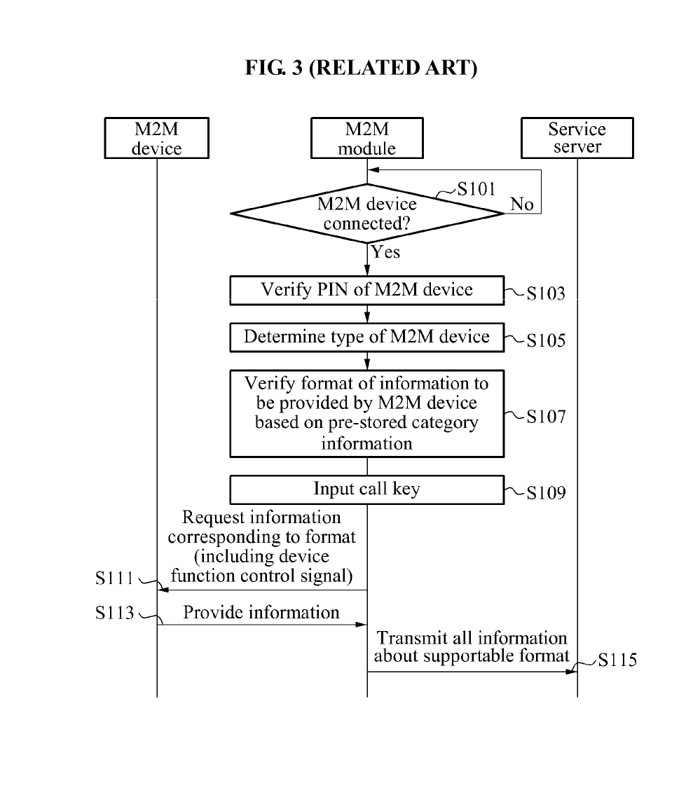

FIG. 4 is a diagram illustrating a basic scenario for applying an object-to-object intelligent network (O2N) communication system providing multiple transmission channels according to an embodiment of the present invention;

FIG. 5 is a diagram illustrating access networks for applying an O2N communication system providing multiple transmission channels according to an embodiment of the present invention;

FIG. 6 is a diagram illustrating a configuration for providing transmission channel selection information in an O2N communication system providing multiple transmission channels according to an embodiment of the present invention;

FIG. 7 is a diagram illustrating an O2N communication system providing multiple transmission channels according to an embodiment of the present invention;

FIG. 8 is a diagram illustrating an M2M device in an O2N communication system providing multiple transmission channels according to an embodiment of the present invention;

FIG. 9 is a flowchart illustrating an operating method of an O2N communication system providing multiple transmission channels according to an embodiment of the present invention;

FIG. 10 is a flowchart illustrating an operating method of an O2N communication system providing multiple transmission channels according to another embodiment of the present invention;

FIG. 11 is a flowchart illustrating an operating method of an O2N communication system providing multiple transmission channels according to still another embodiment of the present invention;

FIG. 12 is a flowchart illustrating an operating method of an O2N communication system providing multiple transmission channels according to yet another embodiment of the present invention;

FIG. 13 is a flowchart illustrating an operating method of an O2N communication system providing multiple transmission channels according to further another embodiment of the present invention;

FIG. 14 is a flowchart illustrating an operating method of an O2N communication system providing multiple transmission channels according to still another embodiment of the present invention; and

FIG. 15 is a flowchart illustrating an operating method of an O2N communication system providing multiple transmission channels according to yet another embodiment of the present invention.

### DETAILED DESCRIPTION

The principles of the present invention are exemplified. Therefore, those skilled in the art can invent various apparatuses that implement the principles of the present invention and are included in the concept and range of the present invention, although the apparatuses are not explicitly described or illustrated herein.

In addition, it should be noted that all conditional terms and embodiments provided herein are intended only for the purpose of providing a sufficient understanding of the present invention and are not limited to embodiments and states provided herein. In addition, all the descriptions providing particular embodiments, in addition to the principles, aspects, and embodiments of the present invention, are intended to include structural and functional equivalents.

The foregoing purposes, features, and advantages will become more apparent by providing the following description with reference to the accompanying drawings. When it is determined that a detailed description is related to a related known function or configuration which may make the purpose of the present disclosure unnecessarily ambiguous in the description, such a detailed description will be omitted. Exemplary embodiments of the present invention will now be described in detail with reference to the accompanying drawings.

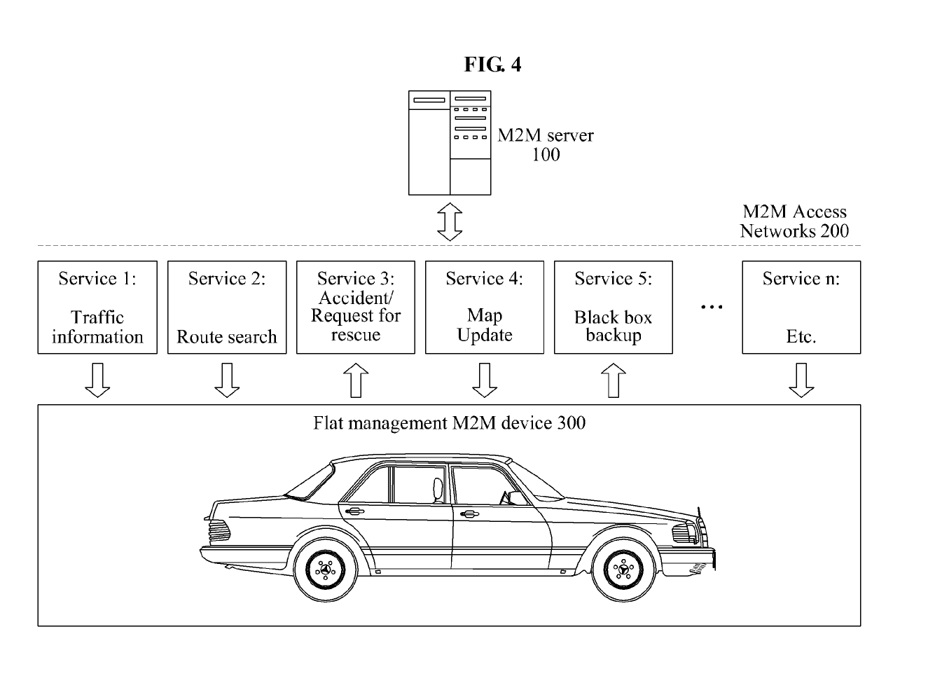

FIG. 4 is a diagram illustrating a basic scenario for applying an object-to-object intelligent network (O2N) communication system providing multiple transmission channels according to an embodiment of the present invention. The O2N communication system may be based on implementation of an information providing service between an O2N communication server 100, hereinafter referred to as the “machine to machine (M2M) server”, and an O2N communication device 300, hereinafter referred to as the “M2M device”, of a user through M2M access networks 200. Hereinafter, the M2M device may include, for example, a flat management M2M device.

As shown in FIG. 4, when the M2M device 300 is provided in a vehicle, information to be provided through the M2M access networks 200 may include traffic information, route search information, accident or request for rescue information, map update information of a navigation device, and image/audio information of a black box. The information may be uploaded from the M2M device 300 to the M2M server 100, or may be downloaded from the M2M server 100 in response to a request from the M2M device 300. A charge may be determined based on a usage cost, a transmission bandwidth, an urgency of providing the information, and a volume of the data.

For example, the traffic information or the route search information may be downloaded from the M2M server 100 in response to a request from the M2M device 300. Traffic information for a roadway segment or a region, or information on a route to a destination may include a relatively small amount of data, and an urgency of providing the information may be relatively low. In contrast, although the accident or request for rescue information may be transmitted using a small amount of data, the accident or request for rescue information may be classified as information to be urgently transmitted from the M2M device 300 to the M2M server 100 at a relatively low error rate. In addition, although the map update information of the navigation device may not need to be provided on an urgent basis, the map update information may include a great quantity of graphic information and thus, a large volume of data may need to be transmitted from the M2M server 100 to the M2M device 300. Further, the image/audio information provided from the black box provided in the M2M device 300 may correspond to a large volume of data to be transmitted from the M2M device 300 to the M2M server 100.

Accordingly, in the O2N communication system, the M2M access networks 200 to connect the M2M device 300 and the M2M server 100 may require a guarantee of an error rate, a data rate corresponding to an urgency of providing information, and a bandwidth for transmitting both a large volume of information and a small amount of data. However, when a high bandwidth, a high data rate, and a low error rate are applied to the M2M access networks 200, an unnecessary charge and wasted network performance may result, depending on information to be provided.

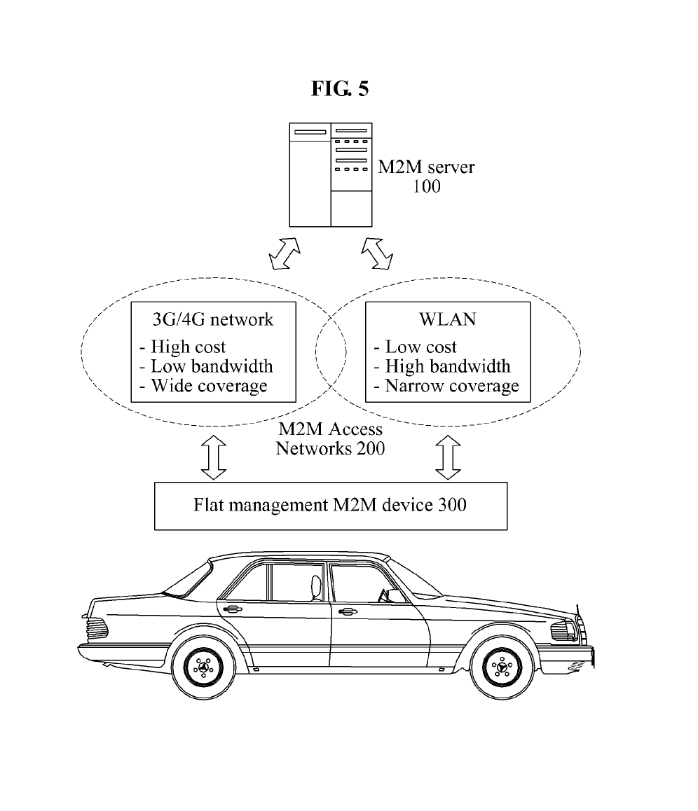

FIG. 5 is a diagram illustrating access networks for applying an O2N communication system providing multiple transmission channels according to an embodiment of the present invention. In the O2N communication system, each of the M2M device 300 and the M2M server 100 may include a means for communication by configuring the M2M access networks 200 using at least two transmission channels. Referring to FIG. 5, a third generation (3G)/fourth generation (4G) network may be provided as a first network, and a wireless local area network (WLAN) may be provided as a second network. The 3G/4G network corresponding to the first network may have characteristics of a relatively high usage cost, a relatively low bandwidth, and a relatively wide coverage, and the WLAN corresponding to the second network may have characteristics of a relatively low cost, a relatively high bandwidth, and a relatively limited coverage. Accordingly, as described with reference to FIG. 4, in terms of a bandwidth for transmission information, the traffic information, the route search information, the accident or request for rescue information, and the like may be assigned to the first network for transmission, and the map update information of the navigation device, and the image/audio information of the black box may be assigned to the second network for transmission. However, error rates or data rates of the 3G/4G network and the WLAN may be determined based on a connection state with the M2M device 300, and a status of network traffic may be changed continuously by another user. Accordingly, transmission information may not be assigned and fixed for each of the plurality of M2M access networks 200. In addition, when the M2M device 300 has a mobile capability, the M2M device 300 may be connected to a plurality of M2M access networks 200 having different characteristics in each region and thus, a transmission channel for an information providing service may need to be changed as well.

Accordingly, an aspect of the present invention discloses the M2M access networks 200 including a plurality of networks between the M2M device 300 and the M2M server 100, and provides the O2N communication system providing multiple transmission channels that may transmit information for enabling the M2M device 30 to select a transmission channel from among the M2M access networks 200 based on a usage cost, a connection state of a network, transmission information including an error rate and a data rate, and the like. In addition, the O2N communication system may select a transmission channel from among the M2M access networks 200, using identifier information of a packet generated by one of the M2M device 300 and the M2M server 100. Further, the O2N communication system may generate a priority table reflecting transmission information including an error rate and a data rate for each service, and select a transmission channel from among the M2M access networks 200 by referring to the priority table.

In addition, another aspect of the present invention provides the O2N communication system providing multiple transmission channels that may select a transmission channel from among the M2M access networks 200 using a fixed parameter, in an environment in which stability of a connection state of the plurality of M2M access networks 200 being connected may be guaranteed when the M2M device 300 has a mobile capability. Also, the O2N communication system may select a transmission channel from among the M2M access networks 200 using a network parameter collected in an environment in which a connection state of the plurality of M2M access networks 200 is unstable, the plurality of M2M access networks 200 having different characteristics in each region or based on a communication environment.

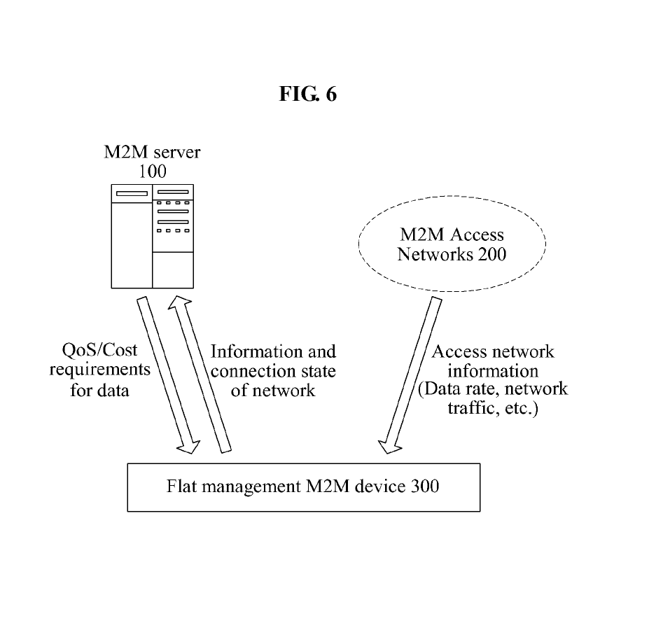

FIG. 6 is a diagram illustrating a configuration for providing transmission channel selection information in an O2N communication system providing multiple transmission channels according to an embodiment of the present invention. The M2M device 300 may implement various policies to select one of a plurality of networks provided in the M2M access networks 200.

Referring to FIG. 6, the M2M device 300 may collect transmission channel information including information about network traffic, a data rate, and a connection state for each channel with respect to the plurality of networks of the M2M access networks 200 being connected, and provide the collected transmission channel information to the M2M server 100. The M2M server 100 may transmit, to the M2M device 300, requirement information including a usage cost and a quality of service (QoS) for each piece of data desired to be serviced, based on the transmission channel information. The M2M device 300 may select one of a plurality of channels from among the M2M access networks 200, based on the transmitted requirement information, and may be provided with a data service through the selected channel.

In this instance, the M2M access networks 200 may be configured to include a separate network for the transmission channel selection information and the requirement information to be transmitted between the M2M device 300 and the M2M server 100. In addition, the M2M access networks 200 may be configured for the M2M device 300 to transmit the transmission channel information and the requirement information through a network selected as a default, among the plurality of networks of the M2M access networks 200 being connected.

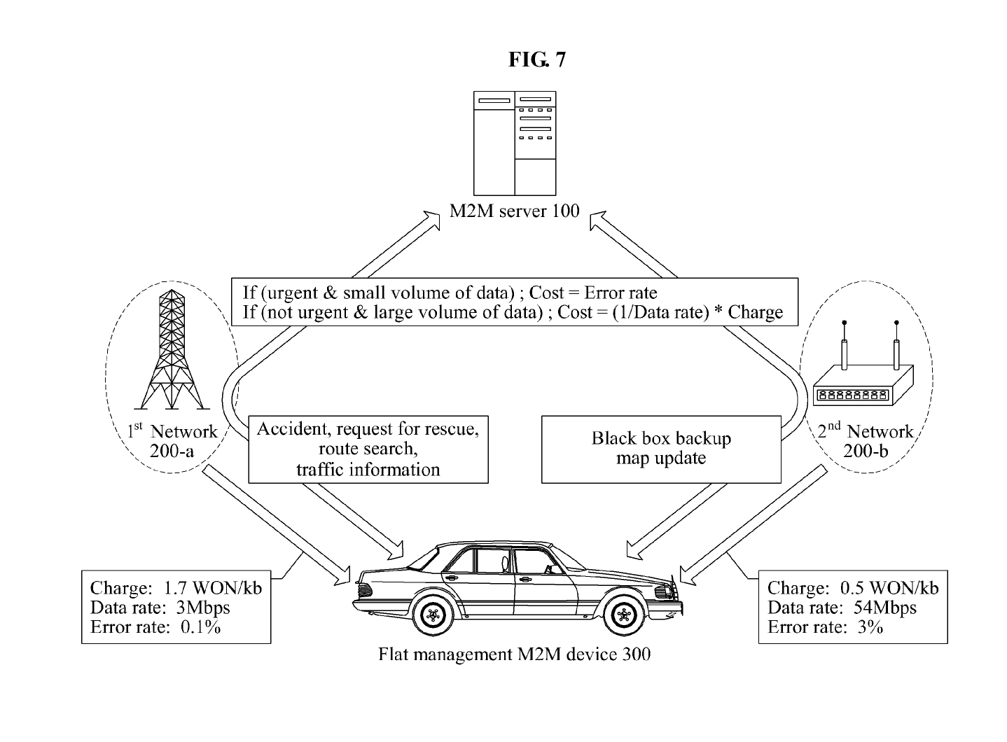

FIG. 7 is a diagram illustrating an O2N communication system providing multiple transmission channels according to an embodiment of the present invention. In the O2N communication system of FIG. 7, a network to be connected for a service may be selected by one of the M2M device 300 and the M2M server 100, based on on conditions or a network environment.

Referring to FIG. 7, the M2M device 300 may collect transmission channel information including error rates, data rates, and usage costs for a first network 200-a and a second network 200-b being connected, and transmit the collected transmission channel information to the M2M server 100. In this instance, one of networks being connected may be selected for use as a default network. The M2M server 100 may transmit, to the M2M device 300, requirement information corresponding to a usage cost, an error rate, and a volume of service data, and an urgency of a service, based on the transmission channel information. The M2M device 300 may select one of a plurality of networks of the M2M access networks 200 being connected, based on the transmitted requirement information, and upload or download service information through the selected network.

In this instance, the O2N communication system may select a transmission channel from among the M2M access networks 200, using identifier information of a packet generated by one of the M2M device 300 and the M2M server 100. In addition, the O2N communication system may generate a priority table reflecting transmission information including an error rate and a data rate for each service, and select a transmission channel from among the M2M access networks 200 by referring to the priority table.

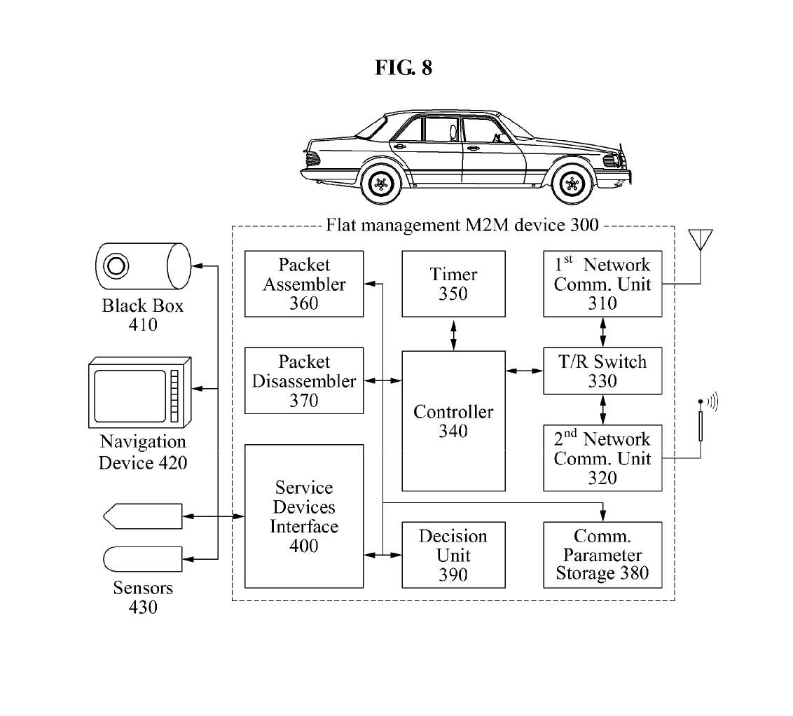

FIG. 8 is a diagram illustrating an M2M device in an O2N communication system providing multiple transmission channels according to an embodiment of the present invention. Referring to FIG. 8, the M2M device 300 may include a first communication unit 310, for example, a first network communication unit, to be connected to one of a plurality of networks constituting the M2M access networks 200 to perform communication, and a second communication unit 320, for example, a second network communication unit, to be connected to another of the plurality of networks to perform communication. The first communication unit 310 and the second communication unit 310 may be connected to the M2M server 100 through the M2M access networks 200, and may be classified as means using different frequencies or different communication schemes. Although for ease of description on features of the present invention, an example of two channels being included in the M2M access networks 200, and the first communication unit 310 and the second communication unit 320 configured in the M2M access network 200 for connection is provided herein, the present invention is not to be limited thereto. The networks constituting the M2M access networks 200 may provide at least two channels. In this instance, the M2M device 300 may include at least two communication units to be connected to the M2M server 100 through respective network channels.

The first communication unit 310 and the second communication unit 320 of the M2M device 300 may be connected to a controller 340 through a transmission/reception switch 330. A packet assembler 360 to construct information to be transmitted through each network channel into a packet, and a packet disassembler 370 to extract information from the packet received through each network channel may be connected to the controller 340.

In addition, a transmission parameter storage 380 to store requirement information and transmission channel information including connection state information containing error rates, data rates, and the like of the first communication unit 310 and the second communication unit 320 to be connected to the M2M access networks 200, and a decision unit 390 to decide a channel of the M2M access networks 200 based on the transmission channel information stored in the transmission parameter storage 380 may be connected to the controller 340.

Further, the M2M device 300 may include service devices to be connected to the controller 340 through a service devices interface 400 for service information to be downloaded from or uploaded to the M2M server 100. The service devices may include a black box 410, a navigation device 420, and a variety of sensors 430.

In the M2M device 300, the decision unit 390 may be implemented by various schemes to determine a channel of the M2M access networks 200.

As an example, the decision unit 390 may be configured to determine a channel based on service information with respect to requirement information and transmission channel information of the M2M access networks 200.

In particular, the M2M device 300 may collect, through the first communication unit 310 and the second communication unit 320, transmission channel information including error rates, data rates, and usage costs for the first network 200-a and the second network 200-b connected to the M2M device 300, and transmit the collected transmission channel information to the M2M server 100. The M2M server 100 may transmit, to the M2M device 300, requirement information corresponding to a usage cost, an error rate, and a volume of service data, and an urgency of a service, based on the transmission channel information. The M2M device 300 may store the received requirement information and the transmission channel information in the transmission parameter storage 380. The decision unit 390 may generate channel decision information for each piece of service information, based on the information stored in the transmission parameter storage 380. The channel decision information for each piece of service information may include a transmission time corresponding to a volume of service data, and a corresponding usage cost. By calculating the transmission time and the corresponding usage cost for each of the first network 200-a and the second network 200-b connected to the M2M device 300, a network available at a lower cost may be selected, or a network providing a relatively high data rate and a relatively low error rate may be selected for a case of an urgent service. Such selection of a network may be determined based on a policy corresponding to a transmission cost, a transmission rate, a transmission time, and a QoS, and a method of selecting the network may be set in the decision unit 390 in advance.

As another example, the decision unit 390 may be configured for identifier information of a packet generated by one of the M2M device 300 and the M2M server 100 to be extracted from one of the packet assembler 360 and the packet disassembler 370, and for a fixed transmission channel of the M2M access networks 200 to be assigned and selected based on the extracted identifier information.

As still another example, the decision unit 390 may be configured for a priority table reflecting transmission information including an error rate, and a data rate for each service, the transmission channel information, and the requirement information of the M2M access networks 200 to be provided, and a network to be selected by referring to the priority table. The priority table may be provided in the decision unit 390 of the M2M device 300. In addition, the priority table may be provided in the M2M server, whereby the configuration of the M2M device 300 may be simplified.

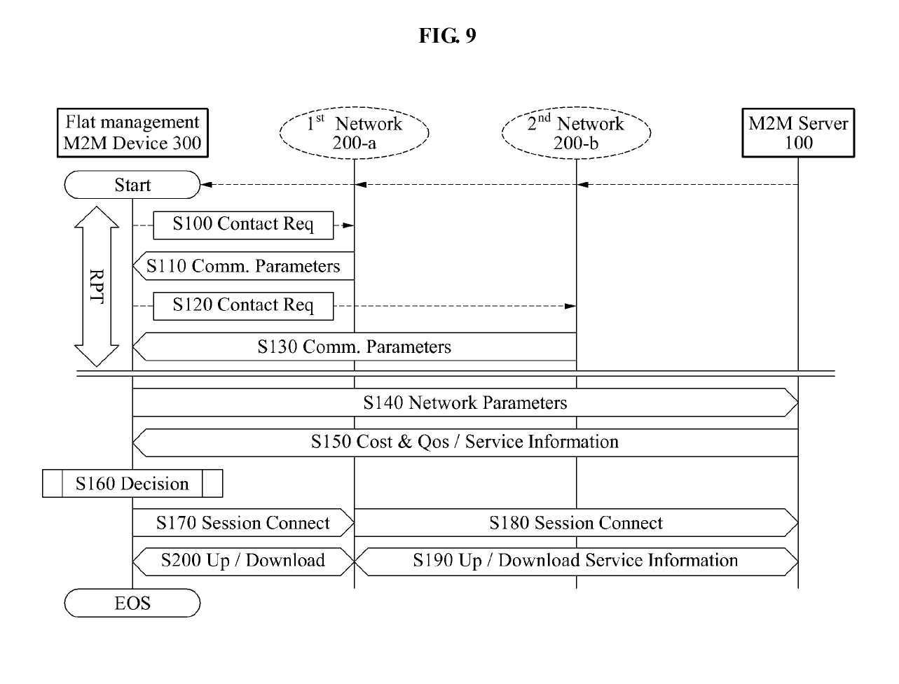

FIG. 9 is a flowchart illustrating an operating method of an O2N communication system providing multiple transmission channels according to an embodiment of the present invention. The O2N communication system may provide at least two transmission channels, and each channel may include a network device. For example, when two transmission channels, for example, the first network 200-a and the second network 200-b, are provided, the first network 200-a may be implemented by a 3G/4G network, and the second network 200-b may be implemented by a WLAN. The first network 200-a may include a 3G/4G base station, and the second network 200-b may include a WLAN access point (AP).

An aspect of the present invention provides the O2N communication system that may select a transmission channel from among the M2M access networks 200 using a network parameter collected in an environment in which a connection state of the plurality of M2M access networks 200 is unstable, the plurality of M2M access networks 200 having different characteristics in each region or based on a communication environment. In addition, another aspect of the present invention provides an operating method of the O2N communication system that may select a transmission channel from among the M2M access networks 200 using a fixed parameter, in an environment in which stability of a connection state of the plurality of M2M access networks 200 being connected to the M2M device 300 may be guaranteed.

As an example, an operating method of the O2N communication system in an environment in which a connection state of M2M access networks 200 is not guaranteed will be described. Here, the O2N communication system may include the M2M server 110, the M2M device 300, and the M2M access networks 200 including the first network 200-a and the second network 200-b as at least two networks for connecting the M2M server 100 and the M2M device 300.

The method may include:

when an O2N communication operation of the M2M device 300 is initiated,
operation S100 of transmitting, by the M2M device 300, a contact request to one of networks provided in the M2M access networks 200;
operation S110 of transmitting, by the network receiving the transmitted access request, transmission channel information including an error rate, a data rate, and a usage cost to the M2M device 300 in response to the contact request;
operation S120 of transmitting, by the M2M device 300, a contact request to another of the networks provided in the M2M access networks 200;
operation S130 of transmitting, by the other network receiving the transmitted access request, transmission channel information including an error rate, a data rate, and a usage cost to the M2M device 300 in response to the contact request; and
operation S140 of transmitting, by the M2M device 300, transmission channel information received from the network along with an identifier of the M2M device 300, to the M2M server 100 via one of the networks provided in the M2M access networks 200. Here, the identifier of the M2M device 300 may correspond to an identifier (ID) or an Internet protocol (IP).

The method may further include:
operation S150 of calculating, by the M2M server 100 receiving the transmission channel information from the M2M device 300, service information to be provided, a QoS, and a service cost based on the transmission channel information, and transmitting a result of the calculating to the M2M device 300;
operation S160 of determining, by the M2M device 300, one of the networks provided in the M2M access networks 200, based on the service information, the QoS, and the service cost provided by the M2M server 100, and the transmission channel information received from the networks;
operations S170 and S180 of selecting, by the M2M device 300, the determined network, and transmitting, to the M2M server 100, service request information including service information desired to be provided, along with the identifier of the M2M device 300 via the determined network; and

operations S190 and S200 of providing, by the M2M server 100 receiving the service request information, a service for uploading or downloading the service information to the M2M device 300 via the network through which the service request information is transmitted. By performing the foregoing operations, an O2N communication service may be completed.

The O2N communication operation of the M2M device 300 may be initiated when a request for O2N communication with respect to the M2M device 300 is received from the M2M server 100 through one of the networks provided in the M2M access networks 200.

Operations S100 to S130 may be performed iteratively in the M2M device 300 at intervals set by a timer 350 when a request for O2N communication is absent.

In operations S110 and S130, least two parameters specifying a transmission channel may be provided as the transmission channel information, and the at least two parameters may include traffic information, a delay time, an error rate, a data rate, and a usage cost.

In operation S160, the M2M device 300 may assign weights to a parameter of a QoS, a parameter of a service cost provided from the M2M server 100, and a parameter of the transmission channel information received from the networks, and select one of the networks provided in the M2M access networks 200 based on a result of the assigning.

As another example, an operating method of the O2N communication system in an environment in which a connection of the M2M access networks 200 is guaranteed will be described. Here, the O2N communication system may include the M2M server 100, the M2M device 300, and the M2M access networks 200 including the first network 200-a and the second network 200-b as at least two networks for connecting the M2M server 100 and the M2M device 300.

The method may include:

when an O2N communication operation of the M2M device 300 is initiated,
operation S140 of transmitting, by the M2M device 300, transmission channel information from networks provided in the M2M access networks 200, along with an identifier of the M2M device 300 to the M2M server 100. Here, the identifier of the M2M device 300 may correspond to an ID or an IP.

The method may further include:
operation S150 of calculating, by the M2M server 100 receiving the transmission channel information from the M2M device 300, service information to be provided, a QoS, and a service cost based on the transmission channel information, and transmitting a result of the calculating to the M2M device 300;
operation S160 of determining, by the M2M device 300, one of the networks provided in the M2M access networks 200, based on the service information, the QoS, and the service cost provided by the M2M server 100, and the transmission channel information received from the networks;
operations S170 and S180 of selecting, by the M2M device 300, the determined network, and transmitting, to the M2M server 100, service request information including service information desired to be provided, along with the identifier of the M2M device 300 via the determined network; and
operations S190 and S200 of providing, by the M2M server 100 receiving the service request information, a service for uploading or downloading the service information to the M2M device 300 via the network through which the service request information is transmitted. By performing the foregoing operations, an O2N communication service may be completed.

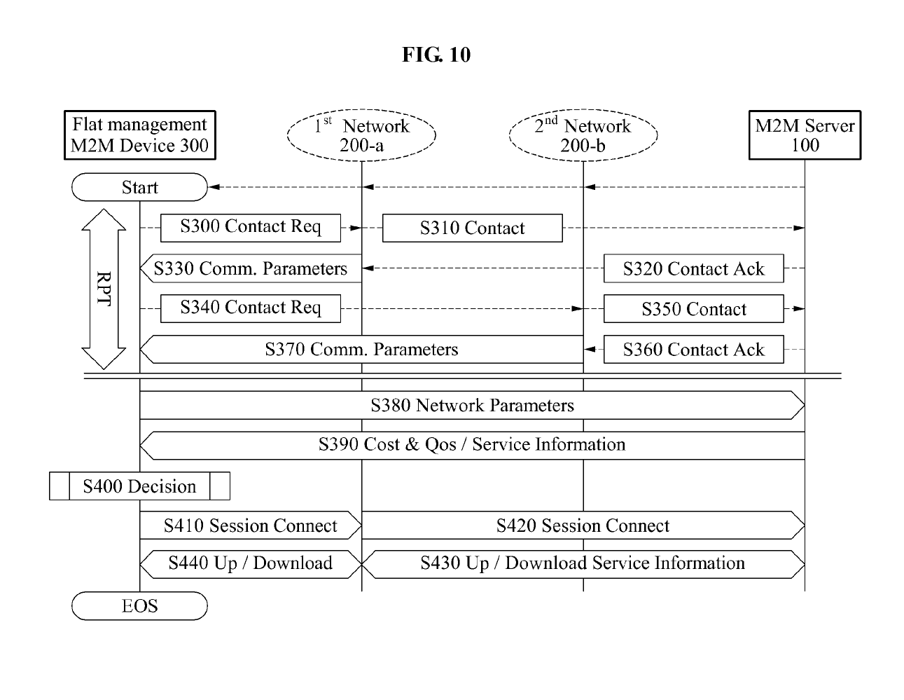

FIG. 10 is a flowchart illustrating an operating method of an O2N communication system providing multiple transmission channels according to another embodiment of the present invention.

An aspect of the present invention provides the O2N communication system that may select a transmission channel from among the M2M access networks 200 using a network parameter collected in an environment in which a connection state of the plurality of M2M access networks 200 is unstable, the plurality of M2M access networks 200 having different characteristics in each region or based on a communication environment. In addition, another aspect of the present invention provides an operating method of the O2N communication system that may select a transmission channel from among the M2M access networks 200 using a fixed parameter, in an environment in which stability of a connection state of the plurality of M2M access networks 200 being connected to the M2M device 300 may be guaranteed.

According to the present embodiment, the operating method of the O2N communication system is directed to verifying a connection of networks provided in the M2M access networks 200 to connect the M2M device 300 and the M2M server 100 in an environment in which a connection state of the plurality of M2M access networks 200 is unstable.

As an example, an operating method of an O2N communication system providing multiple transmission channels in which a consistent connection of M2M access networks 200 is not guaranteed will be described. Here, the O2N communication system may include the M2M server 100, the M2M device 300, and the M2M access networks 200 including the first network 200-a and the second network 200-b as at least two networks for connecting the M2M server 100 and the M2M device 300.

The method may include:

when an O2N communication operation of the M2M device 300 is initiated,
operation S300 of transmitting, by the M2M device 300, connection information of the M2M server 100 and a contact request to one of networks provided in the M2M access networks 200;
operation S310 of requesting, by the network receiving the contact request, a connection to the M2M server 100 based on the connection information of the M2M server 100;
operation S320 of receiving, by the network, a contact acknowledgement from the M2M server 100;
operation S330 of transmitting, by the network, transmission channel information including an error rate, a data rate, and a usage cost to the M2M device 300 in response to the contact request from the M2M device 300;
operation S340 of transmitting, by the M2M device 300, the connection information of the M2M server 100 and a contact request to another of the networks provided in the M2M access networks 200;
operation S350 of requesting, by the other network receiving the contact request, a connection to the M2M server 100 based on the connection information of the M2M server 100;
operation S360 of receiving, by the other network, a contact acknowledgement from the M2M server 100;
operation S370 of transmitting, by the other network, transmission channel information including an error rate, a data rate, and a usage cost to the M2M device 300 in response to the contact request from the M2M device 300; and
operation S380 of transmitting, by the M2M device 300, the transmission channel information received from the networks along with an identifier of the M2M device 300, to the M2M server 100 via one of the networks provided in the M2M access networks 200. Here, the identifier of the M2M device 300 may correspond to an ID or an IP.

The method may further include:
operation S390 of calculating, by the M2M server 100 receiving the transmission channel information from the M2M device 300, service information to be provided, a QoS, and a service cost based on the transmission channel information, and transmitting a result of the calculating to the M2M device 300;
operation S400 of determining, by the M2M device 300, one of the networks provided in the M2M access networks 200, based on the service information, the QoS, and the service cost provided by the M2M server 100, and the transmission channel information received from the networks;
operations S410 and S420 of selecting, by the M2M device 300, the determined network, and transmitting, to the M2M server 100, service request information including service information desired to be provided, along with an ID or an IP of the M2M device 300 via the determined network; and
operations S430 and S440 of providing, by the M2M server 100 receiving the service request information, a service for uploading or downloading the service information to the M2M device 300 via the network through which the service request information is transmitted. By performing the foregoing operations, an O2N communication service may be completed.

The connection information of the M2M server 100 may correspond to one of information for connection including an IP, a uniform resource identifier (URI), a uniform resource locator (URL) of the M2M server 100, and the like.

The O2N communication operation of the M2M device 300 may be initiated when a request for O2N communication with respect to the M2M device 300 is received from the M2M server 100 through one of the networks provided in the M2M access networks 200.

Operations S300, S330, S340, and S370 may be performed iteratively in the M2M device 300 at intervals set by the timer 350 when a request for O2N communication is absent.

In operations S330 and S370, at least two parameters specifying a transmission channel may be provided as the transmission channel information, and the at least two parameters may include traffic information, a delay time, an error rate, a data rate, and a usage cost.

In operation S400, the M2M device 300 may assign weights to a parameter of a QoS, a parameter of a service cost provided from the M2M server 100, and a parameter of the transmission channel information received from the networks, and select one of the networks provided in the M2M access networks 200 based on a result of the assigning.

As another example, an operating method of the O2N communication system in which a consistent connection of M2M access networks 200 is guaranteed will be described. Here, the O2N communication system may include the M2M server 100, the M2M device 300, and the M2M access networks 200 including the first network 200-a and the second network 200-b as at least two networks for connecting the M2M server 100 and the M2M device 300.

The method may include:

when an O2N communication operation of the M2M device 300 is initiated,
operation S380 of transmitting, by the M2M device 300, transmission channel information including error rates, data rates, and usage costs of networks provided in the M2M access networks 200, along with an identifier of the M2M device 300 to the M2M server 100. Here, the identifier of the M2M device 300 may correspond to an ID or an IP.

The method may further include:
operation S390 of calculating, by the M2M server 100 receiving the transmission channel information from the M2M device 300, service information to be provided, a QoS, and a service cost based on the transmission channel information, and transmitting a result of the calculating to the M2M device 300;
operation S400 of determining, by the M2M device 300, one of the networks provided in the M2M access networks 200, based on the service information, the QoS, and the service cost provided by the M2M server 100, and the transmission channel information received from the networks;
operations S410 and S420 of selecting, by the M2M device 300, the determined network, and transmitting, to the M2M server 100, service request information including service information desired to be provided, along with the ID or the IP of the M2M device 300 via the determined network; and
operations S430 and S440 of providing, by the M2M server 100 receiving the service request information, a service for uploading or downloading the service information to the M2M device 300 via the network through which the service request information is transmitted. By performing the foregoing operations, an O2N communication service may be completed.

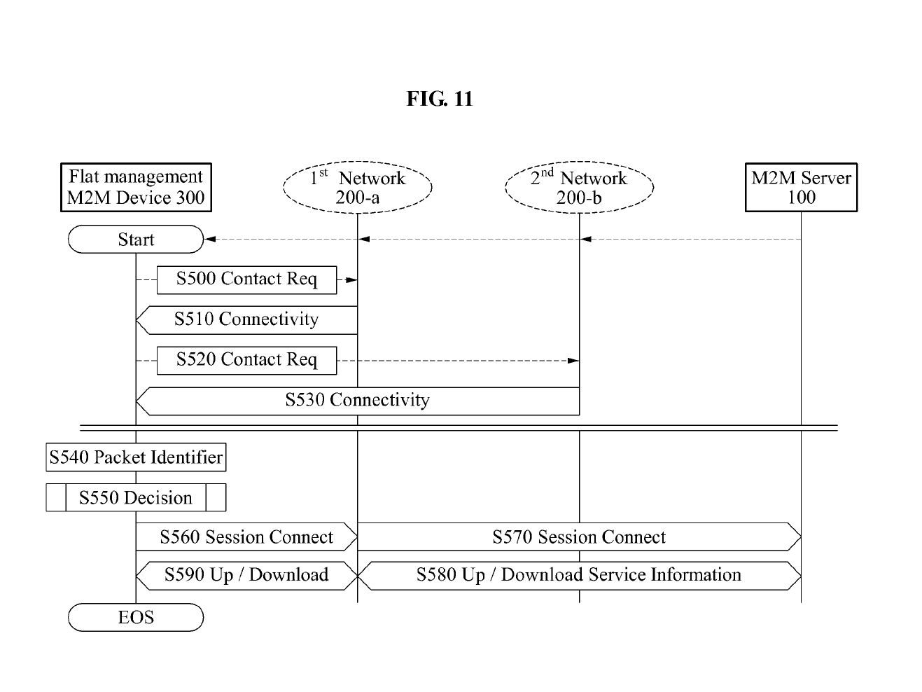

FIG. 11 is a flowchart illustrating an operating method of an O2N communication system providing multiple transmission channels according to still another embodiment of the present invention. According to the present embodiment, the operating method of the O2N communication system is directed to extracting identifier information of a packet generated by the M2M device or the M2M server 100 from a packet assembler 360 configured to construct information to be transmitted into a packet, or a packet disassembler 370 configured to extract information from the packet received through each network channel, by the M2M device 300, and assigning a fixed transmission channel of the M2M access networks 200 based on the extracted identifier information to enable selection of a transmission channel.

An aspect of the present invention provides the O2N communication system that may verify whether the M2M access networks 200 are being connected, and select a transmission channel based on identifier information of a packet, in an environment in which a connection state of the plurality of M2M access networks 200 having different characteristics in each region or based on a communication environment is unstable. Another aspect of the present invention provides an operating method of the O2N communication system that may select a transmission channel from among the M2M access networks 200 based on identifier information of a packet, in an environment in which stability of a connection state of the plurality of M2M access networks 200 being connected to the M2M device 300 may be guaranteed.

As an example, an operating method of an O2N communication system providing multiple transmission channels in which a connection of a network provided in the M2M access networks 200 is not guaranteed will be described. Here, the O2N communication system may include the M2M server 100, the M2M device 300, and the M2M access networks 200 including the first network 200-a and the second network 200-b as at least two networks for connecting the M2M server 100 and the M2M device 300.

The method may include:

when an O2N communication operation of the M2M device 300 is initiated,
operation S500 of transmitting, by the M2M device 300, a contact request to one of networks provided in the M2M access networks 200;
operation S510 of transmitting, by the network receiving the contact request, a contact acknowledgement to the M2M device 300 in response to the contact request;
operation S520 of transmitting, by the M2M device 300, a contact request to another of the networks provided in the M2M access networks 200;
operation S530 of transmitting, by the other network receiving the contact request, a contact acknowledgement to the M2M device 300 in response to the contact request;
operation S540 of extracting, by the M2M device 300, identifier information of a packet generated by the M2M device or the M2M server 100 from a packet assembler 360 configured to construct information to be transmitted into a packet, or a packet disassembler 370 configured to extract information from the packet received through each network channel;
operation S550 of connecting, by the M2M device 300, a transmission channel of the M2M access networks 200 assigned for each identifier information of the packet; and

operations S560 and S570 of transmitting, by the M2M device 300, service request information including service information desired to be provided, along with an identifier of the M2M device 300 to the M2M server 100 via a network being connected. Here, the identifier of the M2M device 300 may include one of an ID and an IP.

The method may further include:
operations S580 and S590 of providing, by the M2M server 100 receiving the service request information, a service for uploading or downloading the service information to the M2M device 300 via the network through which the service request information is transmitted. By performing the foregoing operations, an O2N communication service may be completed.

As another example, an operating method of the O2N communication system in which a connection of a network provided in the M2M access networks 200 is guaranteed will be described. Here, the O2N communication system may include the M2M server 100, the M2M device 300, and the M2M access networks 200 including the first network 200-a and the second network 200-b as at least two networks for connecting the M2M server 100 and the M2M device 300.

The method may include:

when an O2N communication operation of the M2M device 300 is initiated,
operation S540 of extracting, by the M2M device 300, identifier information of a packet generated by the M2M device or the M2M server 100 from a packet assembler 360 configured to construct information to be transmitted into a packet, or a packet disassembler 370 configured to extract information from the packet received through each network channel;
operation S550 of connecting, by the M2M device 300, a transmission channel of the M2M access networks 200 assigned for each identifier information of the packet; and
operations S560 and S570 of transmitting, by the M2M device 300, service request information including service information desired to be provided, along with an identifier of the M2M device 300 to the M2M server 100 via a network being connected. Here, the identifier of the M2M device 300 may include one of an ID and an IP.

The method may further include:
operations S580 and S590 of providing, by the M2M server 100 receiving the service request information, a service for uploading or downloading the service information to the M2M device 300 via the network through which the service request information is transmitted. By performing the foregoing operations, an O2N communication service may be completed.

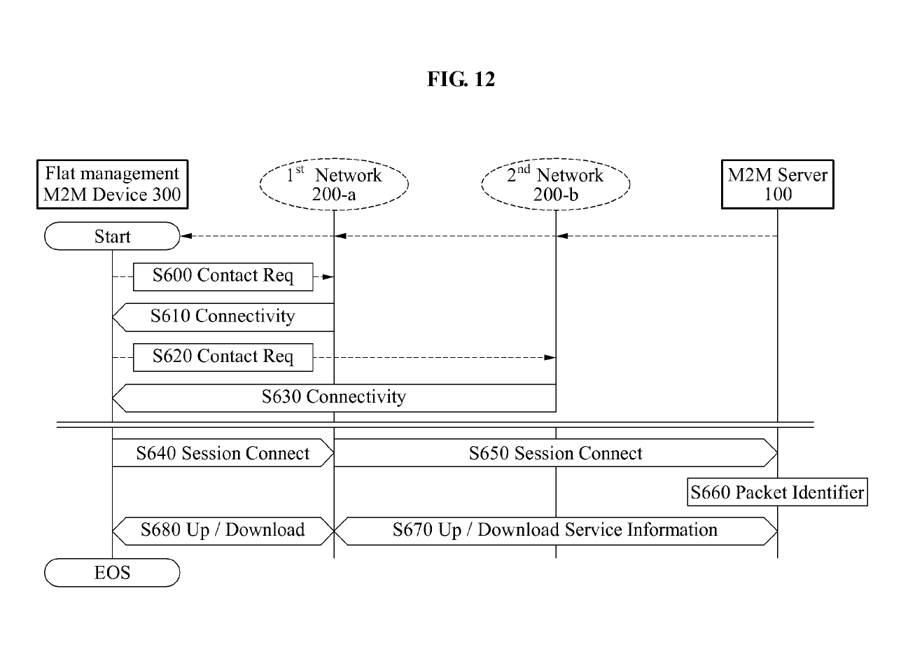

FIG. 12 is a flowchart illustrating an operating method of an O2N communication system providing multiple transmission channels according to yet another embodiment of the present invention. According to the present embodiment, the operating method of the O2N communication system is directed to extracting identifier information of a packet generated by one of the M2M device 300 and the M2M server 100 from the M2M server 100, and assigning a fixed transmission channel of the M2M access networks 200 based on the extracted identifier information to enable selection of a transmission channel.

An aspect of the present invention provides the O2N communication system that may verify whether the M2M access networks 200 are being connected, and select a transmission channel based on identifier information of a packet, in an environment in which a connection state of the plurality of M2M access networks 200 having different characteristics in each region or based on a communication environment is unstable. Another aspect of the present invention provides an operating method of the O2N communication system that may select a transmission channel from among the M2M access networks 200 based on identifier information of a packet, in an environment in which stability of a connection state of the plurality of M2M access networks 200 being connected to the M2M device 300 may be guaranteed.

As an example, an operating method of an O2N communication system providing multiple transmission channels in an environment in which a connection of at least two networks provided in the M2M access networks 200 is not guaranteed will be described. Here, the O2N communication system may include the M2M server 100, the M2M device 300, and the M2M access networks 200 including the first network 200-a and the second network 200-b as the at least two networks for connecting the M2M server 100 and the M2M device 300.

The method may include:

when an O2N communication operation of the M2M device 300 is initiated,
operation S600 of transmitting, by the M2M device 300, a contact request to one of networks provided in the M2M access networks 200;
operation S610 of transmitting, by the network receiving the contact request, a contact acknowledgement to the M2M device 300 in response to the contact request;
operation S620 of transmitting, by the M2M device 300, a contact request to another of the networks provided in the M2M access networks 200;
operation S630 of transmitting, by the other network receiving the contact request, a contact acknowledgement to the M2M device 300 in response to the contact request;
operations S640 and S650 of transmitting, by the M2M device 300, service request information including service information desired to be provided, along with an ID or an IP of the M2M device 300 to the M2M server 100 via one of the networks being connected;
operation S660 of extracting, by the server 100 receiving the service request information, identifier information of a packet generated by the M2M device or the M2M server 100; and
operations S670 and S680 of providing, by the M2M server 100, a service for uploading or downloading the service information to the M2M device 300 via a transmission channel of the M2M access networks 200 assigned for each identifier information of the packet. By performing the foregoing operations, an O2N communication service may be completed.

As another example, an operating method of the O2N communication system in an environment in which a connection of at least two networks provided in the M2M access networks 200 is guaranteed will be described. Here, the O2N communication system may include the M2M server 100, the M2M device 300, and the M2M access networks 200 including the first network 200-a and the second network 200-b as the at least two networks for connecting the M2M server 100 and the M2M device 300.

The method may include:

when an O2N communication operation of the M2M device 300 is initiated,
operations S640 and S650 of transmitting, by the M2M device 300, service request information including service information desired to be provided, along with an identifier of the M2M device 300 to the M2M server 100 via one of networks being connected. Here, the identifier of the M2M device 300 may correspond to one of an ID and an IP.

The method may further include:
operation S660 of extracting, by the server 100 receiving the service request information, identifier information of a packet generated by the M2M device or the M2M server 100; and
operations S670 and S680 of providing, by the M2M server 100, a service for uploading or downloading the service information to the M2M device 300 via a transmission channel of the M2M access networks 200 assigned for each identifier information of the packet. By performing the foregoing operations, an O2N communication service may be completed.

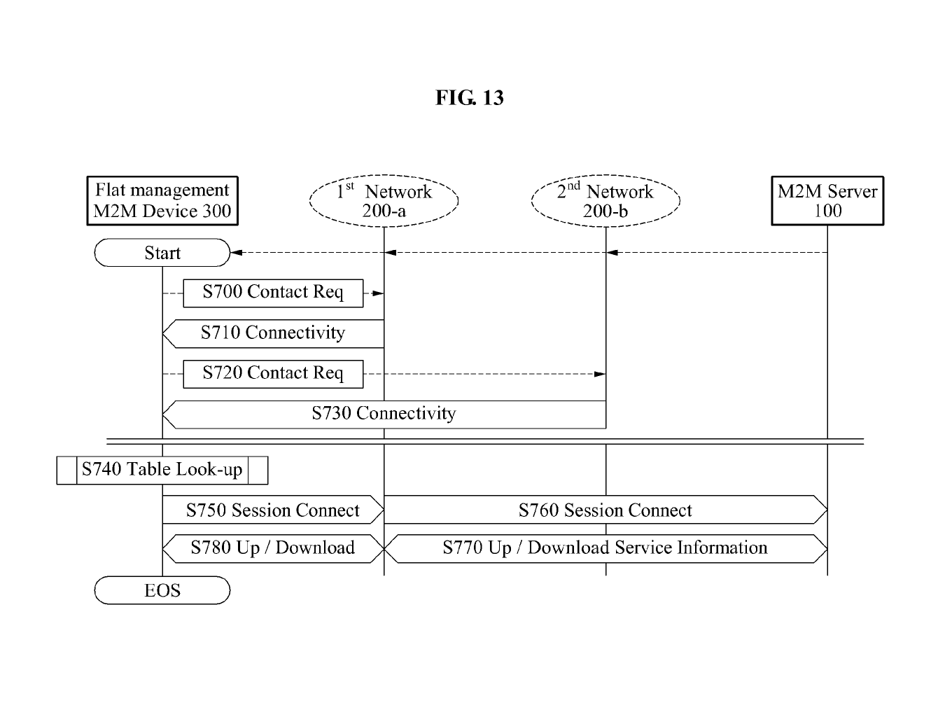

FIG. 13 is a flowchart illustrating an operating method of an O2N communication system providing multiple transmission channels according to further another embodiment of the present invention. According to the present embodiment, the operating method of the O2N communication system is directed to generating, in the decision unit 390 of the M2M device 300, a priority table reflecting transmission information including an error rate, and a data rate for each service and for each network, and selecting a transmission channel from among the M2M access networks 200 by referring to the priority table.

An aspect of the present invention provides the O2N communication system that may verify whether the M2M access networks 200 are being connected, and select a transmission channel based on identifier information of a packet, in an environment in which a connection state of the plurality of M2M access networks 200 having different characteristics in each region or based on a communication environment is unstable. Another aspect of the present invention provides an operating method of the O2N communication system that may select a transmission channel from among the M2M access networks 200 by referring to a priority table, in an environment in which stability of a connection state of the plurality of M2M access networks 200 being connected to the M2M device 300 may be guaranteed.

As an example, an operating method of an O2N communication system providing multiple transmission channels in an environment in which a connection of at least two networks provided in the M2M access networks 200 is not guaranteed will be described. Here, the O2N communication system may include the M2M server 100, the M2M device 300, and the M2M access networks 200 including the first network 200-a and the second network 200-b as the at least two networks for connecting the M2M server 100 and the M2M device 300.

The method may include:

when an O2N communication operation of the M2M device 300 is initiated,
operation S700 of transmitting, by the M2M device 300, a contact request to one of networks provided in the M2M access networks 200;
operation S710 of transmitting, by the network receiving the contact request, a contact acknowledgement to the M2M device 300 in response to the contact request;
operation S720 of transmitting, by the M2M device 300, a contact request to another of the networks provided in the M2M access networks 200;
operation S730 of transmitting, by the other network receiving the contact request, a contact acknowledgement to the M2M device 300 in response to the contact request;
operation S740 of selecting, by the M2M device 300, a transmission channel from among the M2M access networks 200 by referring to a priority table reflecting transmission information including an error rate and a data rate for each network based on service information to connect the selected transmission channel;
operations S750 and S760 of transmitting, by the M2M device 300, service request information including service information desired to be provided, along with an ID or an IP of the M2M device 300 to the M2M server 100 via a network being connected; and
operations S770 and S780 of providing, by the M2M server 100 receiving the service request information, a service for uploading or downloading the service information to the M2M device 300 via the network through which the service request information is transmitted. By performing the foregoing operations, an O2N communication service may be completed.

As another example, an operating method of the O2N communication system in an environment in which a connection of at least two networks provided in the M2M access networks 200 is guaranteed will be described. Here, the O2N communication system may include the M2M server 100, the M2M device 300, and the M2M access networks 200 including the first network 200-a and the second network 200-b as the at least two networks for connecting the M2M server 100 and the M2M device 300.

The method may include:

when an O2N communication operation of the M2M device 300 is initiated,
operation S740 of selecting, by the M2M device 300, a transmission channel from among the M2M access networks 200 by referring to a priority table reflecting transmission information including an error rate and a data rate for each network to connect the selected transmission channel;
operations S750 and S760 of transmitting, by the M2M device 300, service request information including service information desired to be provided, along with an identifier of the M2M device 300 to the M2M server 100 via a network being connected; and
operations S770 and S780 of providing, by the M2M server 100 receiving the service request information, a service for uploading or downloading the service information to the M2M device 300 via the network through which the service request information is transmitted. By performing the foregoing operations, an O2N communication service may be completed.

The O2N communication operation of the M2M device 300 may be initiated when a request for O2N communication with respect to the M2M device 300 is received from the M2M server 100 through one of the networks provided in the M2M access networks 200.

In operation S740, the priority table may be generated based on at least two parameters specifying a transmission channel, and the at least two parameters may include traffic information, a delay time, an error rate, a data rate, and a usage cost for each network.

In operation S740, the priority table may be generated by assigning a weight to a parameter specifying a transmission channel, and assigning a priority based on service data desired to be serviced, and the parameter may include traffic information, a delay time, an error rate, a data rate, and a usage cost for each network.

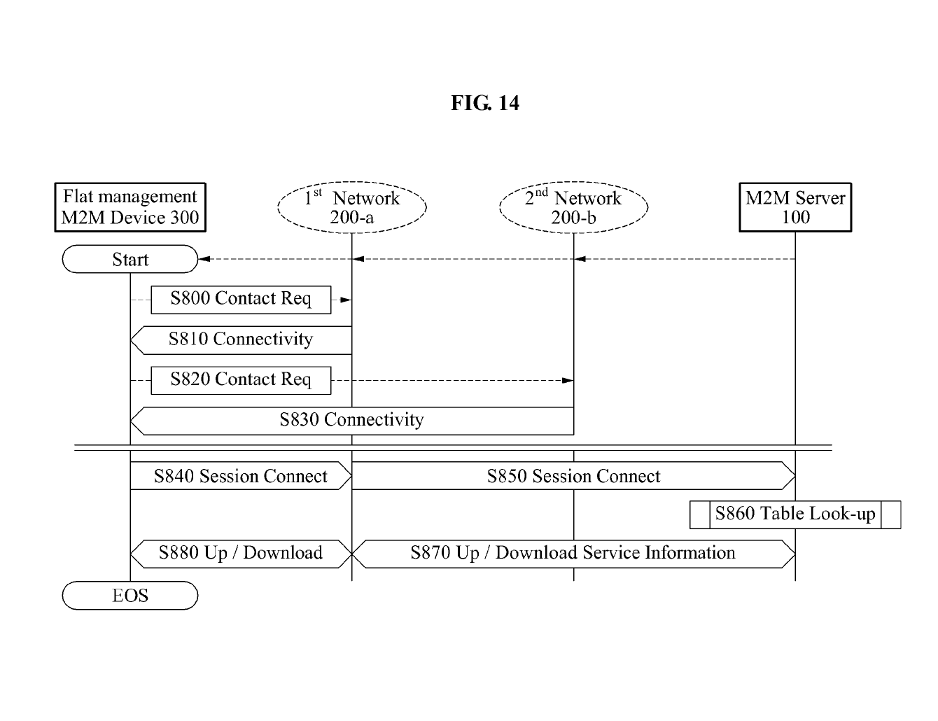

FIG. 14 is a flowchart illustrating an operating method of an O2N communication system providing multiple transmission channels according to still another embodiment of the present invention. According to the present embodiment, the operating method of the O2N communication system is directed to generating, in the M2M server 100, a priority table reflecting transmission information including an error rate, and a data rate for each service and for each network, and selecting a transmission channel from among the M2M access networks 200 by referring to the priority table.

An aspect of the present invention provides the O2N communication system that may verify whether the M2M access networks 200 are being connected, and select a transmission channel by referring to a priority table, in an environment in which a connection state of the plurality of M2M access networks 200 having different characteristics in each region or based on a communication environment is unstable. Another aspect of the present invention provides an operating method of the O2N communication system that may select a transmission channel from among the M2M access networks 200 by referring to a priority table, without verifying whether the M2M access networks 200 are being connected, in an environment in which stability of a connection state of the plurality of M2M access networks 200 being connected to the M2M device 300 may be guaranteed.

As an example, an operating method of an O2N communication system providing multiple transmission channels in which a connection of at least two networks provided in the M2M access networks 200 is not guaranteed will the described. Here, the O2N communication system may include the M2M server 100, the M2M device 300, and the M2M access networks 200 including the first network 200-a and the second network 200-b as the at least two networks for connecting the M2M server 100 and the M2M device 300.

The method may include:

when an O2N communication operation of the M2M device 300 is initiated,
operation S800 of transmitting, by the M2M device 300, a contact request to one of networks provided in the M2M access networks 200;
operation S810 of transmitting, by the network receiving the contact request, a contact acknowledgement to the M2M device 300 in response to the contact request;
operation S820 of transmitting, by the M2M device 300, a contact request to another of the networks provided in the M2M access networks 200;
operation S830 of transmitting, by the other network receiving the contact request, a contact acknowledgement to the M2M device 300 in response to the contact request; and
operations S840 and S850 of selecting, by the M2M device 300, a single network, and transmitting, to the M2M server 100, service request information including service information desired to be provided, along with an identifier of the M2M device 300 via the selected network. Here, the identifier of the M2M device 300 may correspond to one of an ID or an IP of the M2M device 300.

The method may further include:
operation S860 of selecting, by the M2M server 100 receiving the service request information, a transmission channel from among the M2M access networks 200 by referring to a priority table reflecting transmission information including an error rate and a data rate for each network based on service information to connect the selected transmission channel; and
operations S870 and S880 of providing, by the M2M server 100, a service for uploading or downloading the service information to the M2M device 300 via the network being connected. By performing the foregoing operations, an O2N communication service may be completed.

As another example, an operating method of the O2N communication system in which a connection of at least two networks provided in the M2M access networks 200 is guaranteed will be described. Here, the O2N communication system may include the M2M server 100, the M2M device 300, and the M2M access networks 200 including the first network 200-a and the second network 200-b as the at least two networks for connecting the M2M server 100 and the M2M device 300.

The method may include:

when an O2N communication operation of the M2M device 300 is initiated,
operations S840 and S850 of selecting, by the M2M device 300, a single network, and transmitting, to the M2M server 100, service request information including service information desired to be provided, along with an identifier of the M2M device 300 via the selected network. Here, the identifier of the M2M device 300 may correspond to one of an ID or an IP of the M2M device 300.

The method may further include:
operation S860 of selecting, by the M2M server 100 receiving the service request information, a transmission channel from among the M2M access networks 200 by referring to a priority table reflecting transmission information including an error rate and a data rate for each network based on service information to connect the selected transmission channel; and
operations S870 and S880 of providing, by the M2M server 100, a service for uploading or downloading the service information to the M2M device 300 via the network being connected. By performing the foregoing operations, an O2N communication service may be completed.

The O2N communication operation of the M2M device 300 may be initiated when a request for O2N communication with respect to the M2M device 300 is received from the M2M server 100 through one of the networks provided in the M2M access networks 200.

In operation S860, the priority table may be generated based on at least two parameters specifying a transmission channel, and the at least two parameters may include traffic information, a delay time, an error rate, a data rate, and a usage cost for each network.

In operation S860, the priority table may be generated by assigning a weight to a parameter specifying a transmission channel, and assigning a priority based on service data desired to be serviced, and the parameter may include traffic information, a delay time, an error rate, a data rate, and a usage cost for each network.

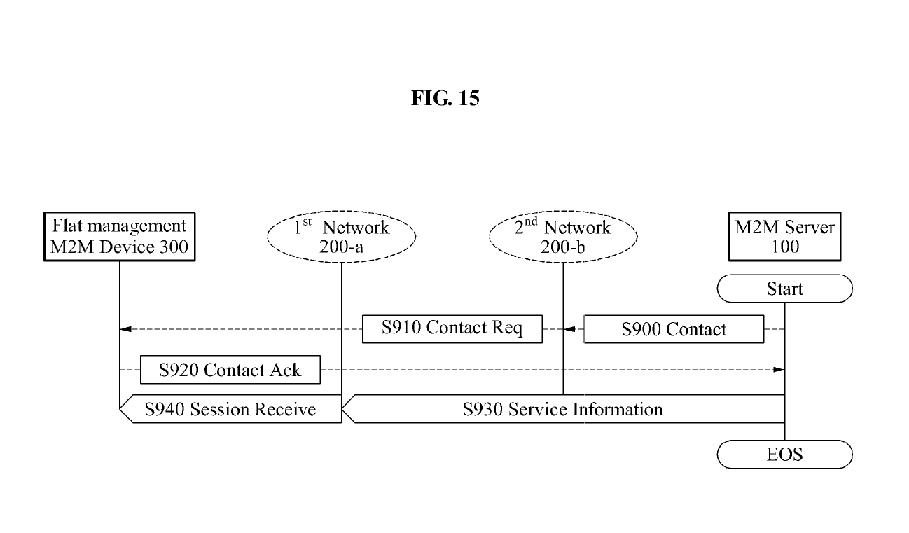

FIG. 15 is a flowchart illustrating an operating method of an O2N communication system providing multiple transmission channels according to yet another embodiment of the present invention. According to the present embodiment, the operating method of the O2N communication system is directed to providing an information service through a predetermined transmission channel of the M2M access networks 200 from the M2M server 100 in order to provide an urgent information service from the M2M server 100 to the M2M device 300 via the M2M access networks 200.

For example, an operating method of an O2N communication system providing multiple transmission channels will be described. Here, the O2N communication system may include the M2M server 100, the M2M device 300, and the M2M access networks 200 including the first network 200-a and the second network 200-b as the at least two networks for connecting the M2M server 100 and the M2M device 300.

The method may include:

when an O2N communication operation is initiated,
operations S900 and S910 of connecting, by the M2M server 100, a predetermined network, among networks provided in the M2M access networks 200, and transmitting a contact request to the M2M device 300 via the predetermined network;
operation S920 of receiving, by the M2M server 100, a contact acknowledgement from the M2M device 300; and
operations S930 and S940 of providing, by the M2M server 100, service information to the M2M device 300 via the network being connected. By performing the foregoing operations, an O2N communication service may be completed.

As described above, according to exemplary embodiments of the present invention, there is provided an O2N communication system providing multiple transmission channels and an operating method of the O2N communication system in which M2M access networks may be configured to include a plurality of networks for connecting an M2M device and an M2M server, the M2M device may provide the M2M server with transmission channel information including an error rate, a data rate, and cost information for each channel of a network being connected, the M2M server may provide the M2M device with requirement information corresponding to a cost, an error rate, and a volume of service data, and an urgency of a service, based on the transmission channel information, thereby enabling a transmission channel corresponding to service information to be selected, identifier information of a packet generated by the M2M device or the M2M server may be extracted, and a transmission channel may be selected from among the M2M access networks based on the extracted identifier information.

In addition, a priority table reflecting transmission information including an error rate, a data rate for each service, the transmission channel information, and the requirement information of the M2M access networks may be provided, and a network may be selected by referring to the priority table.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

### REFERENCES OF RELATED ARTS

### Patent References

(Reference 1) KR10-2012-0016572 A
(Reference 2) KR10-1048854 B1
(Reference 3) KR10-0998753 B1
(Reference 4) KR10-2011-0037002 A
(Reference 5) KR10-2012-0061337 A
(Reference 6) KR10-2012-0067459 A
(Reference 7) KR10-2011-0117030 A
(Reference 8) KR10-1116827 B1
(Reference 9) KR10-2012-0061741 A
(Reference 10) KR10-2011-0095395 A
(Reference 11) KR10-2012-0066662 A
(Reference 12) EP2288091 A1
(Reference 13) US20120069823 A1
(Reference 14) WO2011155778 A1
(Reference 15) WO2011008498 A2
(Reference 16) WO2011116713 A2
(Reference 17) WO2011119680 A2
(Reference 18) WO2011129674 A2
(Reference 19) WO2011132103 A1
(Reference 20) WO2011134378 A1
(Reference 21) WO2011161541 A2

What is claimed is:

1. An object-to-object intelligent network (O2N) communication system providing multiple transmission channels, the system comprising:
a machine to machine (M2M) server 100;
an M2M device 300; and
M2M access networks 200 comprising a first network 200-a and a second network 200-b as at least two networks for connecting the M2M server 100 and the M2M device 300,
wherein the M2M device 300 collects transmission channel information including information about network traffic, a data rate, and a connection state for each channel with respect to a plurality of networks of the M2M access networks 200 being connected, and provides the collected transmission channel information to the M2M server 100,
the M2M server 100 transmits, to the M2M device 300, requirement information including a usage cost and a quality of service (QoS) for each piece of data desired to be serviced, based on the transmission channel information, and
the M2M device 300 selects one of a plurality of channels from among the M2M access networks 200, based on the transmitted requirement information, and is provided with a data service through the selected channel.

2. An object-to-object intelligent network (O2N) communication system providing multiple transmission channels, the system comprising:
a machine to machine (M2M) server 100;
an M2M device 300; and
M2M access networks 200 comprising a first network 200-a and a second network 200-b as at least two networks for connecting the M2M server 100 and the M2M device 300,
wherein the system enables the M2M device 300 to select a transmission channel from among the M2M access networks 200, or enables the M2M server 100 to select a transmission channel from among the M2M access networks 200, using identifier information of a packet generated by one of the M2M device 300 and the M2M server 100.

3. An object-to-object intelligent network (O2N) communication system providing multiple transmission channels, the system comprising:
a machine to machine (M2M) server 100;
an M2M device 300; and
M2M access networks 200 comprising a first network 200-a and a second network 200-b as at least two networks for connecting the M2M server 100 and the M2M device 300,
wherein the system generates a priority table of a transmission channel reflecting transmission information including an error rate, and a data rate for each service, and enables the M2M device 300 to select a transmission channel from among the M2M access networks 200 by referring to the priority table or enables the M2M server 100 to select a transmission channel from among the M2M access networks 200 by referring to the priority table.

4. The system of one of claims 1 to 3, wherein the M2M device 300 comprises:
a first communication unit 310 to be connected to one of the at least two networks constituting the M2M access networks 200 to perform communication;
a second communication unit 320 to be connected to another of the at least two networks to perform communication;
a transmission/reception switch 330 to selectively connect the first communication unit 310 and the second communication unit 320 to a controller 340;
a packet assembler 360 connected to the controller 340 to construct information to be transmitted through each network channel into a packet;
a packet disassembler 370 connected to the controller 340 to extract information from the packet received through each network channel;
a transmission parameter storage 380 connected to the controller 340 to store requirement information and transmission channel information including connection state information including error rates and data rates of the first communication unit 310 and the second communication unit 320 to be connected to the M2M access networks 200;
a decision unit 390 connected to the controller 340 to decide a channel of the M2M access networks 200 based on the transmission channel information stored in the transmission parameter storage 380; and
a service devices interface 400 to connect service devices to the controller 340 for service information to be downloaded from or uploaded to the M2M server 100,
wherein the service devices comprises a black box 410, a navigation device 420, and a variety of sensors 430.

5. The system of claim 4, wherein:
the M2M device 300 collects, through the first communication unit 310 and the second communication unit 320, transmission channel information including error rates, data rates, and usage costs for the first network 200-a and the second network 200-b connected to the M2M device 300, and transmits the collected transmission channel information to the M2M server 100,
the M2M server 100 transmits, to the M2M device 300, requirement information corresponding to a usage cost, an error rate, and a volume of service data, and an urgency of a service, based on the transmission channel information,
the M2M device 300 stores the received requirement information and the transmission channel information in the transmission parameter storage 380, and
the decision unit 390 generates channel decision information for each piece of service information, based on the information stored in the transmission parameter storage 380.

6. The system of claim 4, wherein the M2M device 300 extracts identifier information of a packet generated by one of the M2M device 300 and the M2M server 100 from the packet assembler 360 or the packet disassembler 370, and assigns a fixed transmission channel of the M2M access networks 200 to the decision unit 390 for each identifier information of the packet to enable selection of a transmission channel.

7. The system of claim 4, wherein the M2M device 300 provides the decision unit 390 with a priority table reflecting transmission information including an error rate and a data rate for each service, the transmission channel information, and the requirement information of the M2M access networks 200, and selects a network by referring to the priority table.

8. The system of claim 4, wherein the M2M device 300 extracts packet identifier information of service information from the M2M server 100, and assigns a fixed transmission channel of the M2M access networks 200 for each extracted identifier information of the packet to be connected to the M2M server 100.

9. The system of claim 4, wherein the M2M device 300 provides the M2M server 100 with a priority table reflecting transmission information including an error rate, and a data rate for each service, the transmission channel information, and the requirement information of the M2M access networks 200, and enables the M2M server to select a network by referring to the priority table.

10. An operating method of an object-to-object intelligent network (O2N) communication system providing multiple transmission channels in an environment in which a connection state of machine to machine (M2M) access networks 200 is not guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S100 of transmitting, by the M2M device 300, a contact request to one of networks provided in the M2M access networks 200;
operation S110 of transmitting, by the network receiving the transmitted access request, transmission channel information including an error rate, a data rate, and a usage cost to the M2M device 300 in response to the contact request;
operation S120 of transmitting, by the M2M device 300, a contact request to another network, among the networks provided in the M2M access networks 200;
operation S130 of transmitting, by the other network receiving the transmitted access request, transmission channel information including an error rate, a data rate, and a usage cost to the M2M device 300 in response to the contact request;
operation S140 of transmitting, by the M2M device 300, transmission channel information received from the networks along with an identifier of the M2M device 300 to the M2M server 100, via one of the networks provided in the M2M access networks 200;
operation S150 of calculating, by the M2M server 100 receiving the transmission channel information from the M2M device 300, service information to be provided, a quality of service (QoS), and a service cost based on the transmission channel information, and transmitting a result of the calculating to the M2M device 300;
operation S160 of determining, by the M2M device 300, one of the networks provided in the M2M access networks 200, based on the service information, the QoS, and the service cost provided by the M2M server 100, and the transmission channel information received from the networks;
operations S170 and S180 of selecting, by the M2M device 300, the determined network, and transmitting, to the M2M server 100, service request information including service information desired to be provided, along with the identifier of the M2M device 300 via the determined network; and
operations S190 and S200 of providing, by the M2M server 100 receiving the service request information, a service for uploading or downloading the service information to the M2M device 300 via the network through which the service request information is transmitted.

11. The method of claim 10, wherein the identifier of the M2M device 300 corresponds to one of an identifier (ID) or an Internet protocol (IP), or data to be used to identify the M2M device 300.

12. The method of claim 10, wherein the O2N communication operation of the M2M device 300 is initiated when a request for O2N communication with respect to the M2M device 300 is received from the M2M server 100 through one of the networks provided in the M2M access networks 200.

13. The method of claim 10, wherein operations S100 to S130 are performed iteratively in the M2M device 300 at intervals set by a timer 350 when a request for O2N communication is absent.

14. The method of claim 10, wherein:
at least two parameters specifying a transmission channel are provided as the transmission channel information in operations S110 and S130, and
the at least two parameters comprise traffic information, a delay time, an error rate, a data rate, and a usage cost.

15. The method of claim 10, wherein operation S160 comprises assigning, by the M2M device 300, weights to a parameter of a QoS, a parameter of a service cost provided from the M2M server 100, and a parameter of the transmission channel information received from the networks, and selecting one of the networks provided in the M2M access networks 200 based on a result of the assigning.

16. An operating method of an object-to-object intelligent network (O2N) communication system providing multiple transmission channels in an environment in which a connection of machine to machine (M2M) access networks 200 is guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S140 of transmitting, by the M2M device 300, transmission channel information from networks provided in the M2M access networks 200, along with an identifier of the M2M device 300 to the M2M server 100;
operation S150 of calculating, by the M2M server 100 receiving the transmission channel information from the M2M device 300, service information to be provided, a quality of service (QoS), and a service cost based on the transmission channel information, and transmitting a result of the calculating to the M2M device 300;
operation S160 of determining, by the M2M device 300, one of the networks provided in the M2M access networks 200, based on the service information, the QoS, and the service cost provided by the M2M server 100, and the transmission channel information received from the networks;
operations S170 and S180 of selecting, by the M2M device 300, the determined network, and transmitting, to the M2M server 100, service request information including service information desired to be provided, along with the identifier of the M2M device 300 via the determined network; and
operations S190 and S200 of providing, by the M2M server 100 receiving the service request information, a service for uploading or downloading the service information to the M2M device 300 via the network through which the service request information is transmitted.

17. The method of claim 16, wherein the identifier of the M2M device 300 corresponds to one of an identifier (ID) or an Internet protocol (IP), or data to be used to identify the M2M device 300.

18. An operating method of an object-to-object intelligent network (O2N) communication system providing multiple transmission channels in which a consistent connection of machine to machine (M2M) access networks 200 is not guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S300 of transmitting, by the M2M device 300, connection information of the M2M server 100 and a contact request to one of networks provided in the M2M access networks 200;
operation S310 of requesting, by the network receiving the contact request, a connection to the M2M server 100 based on the connection information of the M2M server 100;
operation S320 of receiving, by the network, a contact acknowledgement from the M2M server 100;
operation S330 of transmitting, by the network, transmission channel information including an error rate, a data rate, and a usage cost to the M2M device 300 in response to the contact request from the M2M device 300;
operation S340 of transmitting, by the M2M device 300, the connection information of the M2M server 100 and a contact request to another of the networks provided in the M2M access networks 200;
operation S350 of requesting, by the other network receiving the contact request, a connection to the M2M server 100 based on the connection information of the M2M server 100;
operation S360 of receiving, by the other network, a contact acknowledgement from the M2M server 100;
operation S370 of transmitting, by the other network, transmission channel information including an error rate, a data rate, and a usage cost to the M2M device 300 in response to the contact request from the M2M device 300;
operation S380 of transmitting, by the M2M device 300, the transmission channel information received from the networks along with an identifier of the M2M device 300, to the M2M server 100 via one of the networks provided in the M2M access networks 200;
operation S390 of calculating, by the M2M server 100 receiving the transmission channel information from the M2M device 300, service information to be provided, a quality of service (QoS), and a service cost based on the transmission channel information, and transmitting a result of the calculating to the M2M device 300;
operation S400 of determining, by the M2M device 300, one of the networks provided in the M2M access networks 200, based on the service information, the QoS, and the service cost provided by the M2M server 100, and the transmission channel information received from the networks;
operations S410 and S420 of selecting, by the M2M device 300, the determined network, and transmitting, to the M2M server 100, service request information including service information desired to be provided, along with an identifier (ID) or an Internet Protocol (IP) of the M2M device 300 via the determined network; and
operations S430 and S440 of providing, by the M2M server 100 receiving the service request information, a service for uploading or downloading the service information to the M2M device 300 via the network through which the service request information is transmitted.

19. The method of claim 18, wherein the connection information of the M2M server 100 corresponds to one of information for connection comprising an IP, a uniform resource identifier (URI), and a uniform resource locator (URL) of the M2M server 100.

20. The method of claim 18, wherein the identifier of the M2M device 300 corresponds to one of the ID or the IP.

21. The method of claim 18, wherein the O2N communication operation of the M2M device 300 is initiated when a request for O2N communication with respect to the M2M device 300 is received from the M2M server 100 through one of the networks provided in the M2M access networks 200.

22. The method of claim 18, wherein operations S300, S330, S340, and S370 are performed iteratively in the M2M device 300 at intervals set by a timer 350 when a request for O2N communication is absent.

23. The method of claim 18, wherein:
at least two parameters specifying a transmission channel are provided as the transmission channel information in operations S330 and S370, and
the at least two parameters comprise traffic information, a delay time, an error rate, a data rate, and a usage cost.

24. The method of claim 18, wherein operation S400 comprises assigning, by the M2M device 300, weights to a parameter of a QoS, a parameter of a service cost provided from the M2M server 100, and a parameter of the transmission channel information received from the networks, and selecting one of the networks provided in the M2M access networks 200 based on a result of the assigning.

25. An operating method of an object-to-object intelligent network (O2N) communication system providing multiple transmission channels in which a consistent connection of machine to machine (M2M) access networks 200 is guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S380 of transmitting, by the M2M device 300, transmission channel information including error rates, data rates, and usage costs of networks provided in the M2M access networks 200, along with an identifier of the M2M device 300 to the M2M server 100;
operation S390 of calculating, by the M2M server 100 receiving the transmission channel information from the M2M device 300, service information to be provided, a quality of service (QoS), and a service cost based on the transmission channel information, and transmitting a result of the calculating to the M2M device 300;
operation S400 of determining, by the M2M device 300, one of the networks provided in the M2M access networks 200, based on the service information, the QoS, and the service cost provided by the M2M server 100, and the transmission channel information received from the networks;
operations S410 and S420 of selecting, by the M2M device 300, the determined network, and transmitting, to the M2M server 100, service request information including service information desired to be provided, along with an identifier (ID) or an Internet Protocol (IP) of the M2M device 300 via the determined network; and
operations S430 and S440 of providing, by the M2M server 100 receiving the service request information, a service for uploading or downloading the service information to the M2M device 300 via the network through which the service request information is transmitted.

26. An operating method of an object-to-object intelligent network (O2N) communication system providing multiple transmission channels in which a connection of a network provided in machine to machine (M2M) access networks 200 is not guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S500 of transmitting, by the M2M device 300, a contact request to one of networks provided in the M2M access networks 200;
operation S510 of transmitting, by the network receiving the contact request, a contact acknowledgement to the M2M device 300 in response to the contact request;
operation S520 of transmitting, by the M2M device 300, a contact request to another of the networks provided in the M2M access networks 200;
operation S530 of transmitting, by the other network receiving the contact request, a contact acknowledgement to the M2M device 300 in response to the contact request;
operation S540 of extracting, by the M2M device 300, identifier information of a packet generated by the M2M device or the M2M server 100 from a packet assembler 360 configured to construct information to be transmitted into a packet, or a packet disassembler 370 configured to extract information from the packet received through each network channel;
operation S550 of connecting, by the M2M device 300, a transmission channel of the M2M access networks 200 assigned for each identifier information of the packet;
operations S560 and S570 of transmitting, by the M2M device 300, service request information including service information desired to be provided, along with an identifier of the M2M device 300 to the M2M server 100 via a network being connected; and
operations S580 and S590 of providing, by the M2M server 100 receiving the service request information, a service for uploading or downloading the service information to the M2M device 300 via the network through which the service request information is transmitted.

27. An operating method of an object-to-object intelligent network (O2N) communication system providing multiple transmission channels in which a connection of a network provided in machine to machine (M2M) access networks 200 is guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S540 of extracting, by the M2M device 300, identifier information of a packet generated by the M2M device or the M2M server 100 from a packet assembler 360 configured to construct information to be transmitted into a packet, or a packet disassembler 370 configured to extract information from the packet received through each network channel;
operation S550 of connecting, by the M2M device 300, a transmission channel of the M2M access networks 200 assigned for each identifier information of the packet;
operations S560 and S570 of transmitting, by the M2M device 300, service request information including service information desired to be provided, along with an identifier of the M2M device 300 to the M2M server 100 via a network being connected; and
operations S580 and S590 of providing, by the M2M server 100 receiving the service request information, a service for uploading or downloading the service information to the M2M device 300 via the network through which the service request information is transmitted.

28. An operating method of an object-to-object intelligent network (O2N) communication system providing multiple transmission channels in an environment in which a connection of at least two networks provided in machine to machine (M2M) access networks 200 is not guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S600 of transmitting, by the M2M device 300, a contact request to one of networks provided in the M2M access networks 200;
operation S610 of transmitting, by the network receiving the contact request, a contact acknowledgement to the M2M device 300 in response to the contact request;
operation S620 of transmitting, by the M2M device 300, a contact request to another of the networks provided in the M2M access networks 200;
operation S630 of transmitting, by the other network receiving the contact request, a contact acknowledgement to the M2M device 300 in response to the contact request;
operations S640 and S650 of transmitting, by the M2M device 300, service request information including service information desired to be provided, along with an identifier (ID) or an Internet protocol (IP) of the M2M device 300 to the M2M server 100 via one of the networks being connected;
operation S660 of extracting, by the server 100 receiving the service request information, identifier information of a packet generated by the M2M device or the M2M server 100; and
operations S670 and S680 of providing, by the M2M server 100, a service for uploading or downloading the service information to the M2M device 300 via a transmission channel of the M2M access networks 200 assigned for each identifier information of the packet.

29. An operating method of an object-to-object intelligent network (O2N) communication system providing multiple transmission channels in an environment in which a connection of at least two networks provided in machine to machine (M2M) access networks 200 is guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operations S640 and S650 of transmitting, by the M2M device 300, service request information including service information desired to be provided, along with an identifier of the M2M device 300 to the M2M server 100 via one of networks being connected;
operation S660 of extracting, by the server 100 receiving the service request information, identifier information of a packet generated by the M2M device or the M2M server 100; and
operations S670 and S680 of providing, by the M2M server 100, a service for uploading or downloading the service information to the M2M device 300 via a transmission channel of the M2M access networks 200 assigned for each identifier information of the packet.

30. An operating method of an object-to-object intelligent network (O2N) communication system providing multiple transmission channels in an environment in which a connection of at least two networks provided in machine to machine (M2M) access networks 200 is not guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S700 of transmitting, by the M2M device 300, a contact request to one of networks provided in the M2M access networks 200;
operation S710 of transmitting, by the network receiving the contact request, a contact acknowledgement to the M2M device 300 in response to the contact request;
operation S720 of transmitting, by the M2M device 300, a contact request to another of the networks provided in the M2M access networks 200;
operation S730 of transmitting, by the other network receiving the contact request, a contact acknowledgement to the M2M device 300 in response to the contact request;
operation S740 of selecting, by the M2M device 300, a transmission channel from among the M2M access networks 200 by referring to a priority table reflecting transmission information including an error rate and a data rate for each network based on service information to connect the selected transmission channel;
operations S750 and S760 of transmitting, by the M2M device 300, service request information including service information desired to be provided, along with an identifier (ID) or an Internet protocol (IP) of the M2M device 300 to the M2M server 100 via a network being connected; and
operations S770 and S780 of providing, by the M2M server 100 receiving the service request information, a service for uploading or downloading the service information to the M2M device 300 via the network through which the service request information is transmitted.

31. An operating method of an object-to-object intelligent network (O2N) communication system providing multiple transmission channels in an environment in which a connection of at least two networks provided in machine to machine (M2M) access networks 200 is guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S740 of selecting, by the M2M device 300, a transmission channel from among the M2M access networks 200 by referring to a priority table reflecting transmission information including an error rate and a data rate for each network to connect the selected transmission channel;
operations S750 and S760 of transmitting, by the M2M device 300, service request information including service information desired to be provided, along with an identifier of the M2M device 300 to the M2M server 100 via a network being connected; and
operations S770 and S780 of providing, by the M2M server 100 receiving the service request information, a service for uploading or downloading the service information to the M2M device 300 via the network through which the service request information is transmitted.

32. The method of one of claims 30 and 31, wherein the O2N communication operation of the M2M device 300 is initiated when a request for O2N communication with respect to the M2M device 300 is received from the M2M server 100 through one of the networks provided in the M2M access networks 200.

33. The method of one of claims 30 and 31, wherein:
the priority table is generated based on at least two parameters specifying a transmission channel, and
the at least two parameters comprise traffic information, a delay time, an error rate, a data rate, and a usage cost for each network.

34. The method of one of claims 30 and 31, wherein:
the priority table is generated by assigning a weight to a parameter specifying a transmission channel, and assigning a priority based on service data desired to be serviced, and
the parameter comprises traffic information, a delay time, an error rate, a data rate, and a usage cost for each network.

35. An operating method of an object-to-object intelligent network (O2N) communication system providing multiple transmission channels in which a connection of at least two networks provided in machine to machine (M2M) access networks 200 is not guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operation S800 of transmitting, by the M2M device 300, a contact request to one of networks provided in the M2M access networks 200;
operation S810 of transmitting, by the network receiving the contact request, a contact acknowledgement to the M2M device 300 in response to the contact request;
operation S820 of transmitting, by the M2M device 300, a contact request to another of the networks provided in the M2M access networks 200;
operation S830 of transmitting, by the other network receiving the contact request, a contact acknowledgement to the M2M device 300 in response to the contact request;
operations S840 and S850 of selecting, by the M2M device 300, a single network, and transmitting, to the M2M server 100, service request information including service information desired to be provided, along with an identifier of the M2M device 300 via the selected network;
operation S860 of selecting, by the M2M server 100 receiving the service request information, a transmission channel from among the M2M access networks 200 by referring to a priority table reflecting transmission information including an error rate and a data rate for each network based on service information to connect the selected transmission channel; and
operations S870 and S880 of providing, by the M2M server 100, a service for uploading or downloading the service information to the M2M device 300 via the network being connected.

36. An operating method of an object-to-object intelligent network (O2N) communication system providing multiple transmission channels in which a connection of at least two networks provided in machine to machine (M2M) access networks 200 is guaranteed, the system comprising an M2M server 100, an M2M device 300, and the M2M access networks 200 comprising a first network 200-a and a second network 200-b as at least two networks for connecting the M2M server 100 and the M2M device 300, the method comprising:
when an O2N communication operation of the M2M device 300 is initiated,
operations S840 and S850 of selecting, by the M2M device 300, a single network, and transmitting, to the M2M server 100, service request information including service information desired to be provided, along with an identifier of the M2M device 300 via the selected network;
operation S860 of selecting, by the M2M server 100 receiving the service request information, a transmission channel from among the M2M access networks 200 by referring to a priority table reflecting transmission information including an error rate and a data rate for each network based on service information to connect the selected transmission channel; and
operations S870 and S880 of providing, by the M2M server 100, a service for uploading or downloading the service information to the M2M device 300 via the network being connected.

37. The method of one of claims 35 and 36, wherein the O2N communication operation of the M2M device 300 is initiated when a request for O2N communication with respect to the M2M device 300 is received from the M2M server 100 through one of the networks provided in the M2M access networks 200.

38. The method of one of claims 35 and 36, wherein:
the priority table is generated based on at least two parameters specifying a transmission channel, and
the at least two parameters comprise traffic information, a delay time, an error rate, a data rate, and a usage cost for each network.

39. The method of one of claims 35 and 36, wherein:
the priority table is generated by assigning a weight to a parameter specifying a transmission channel, and assigning a priority based on service data desired to be serviced, and
the parameter comprises traffic information, a delay time, an error rate, a data rate, and a usage cost for each network.

40. An operating method of an object-to-object intelligent network (O2N) communication system providing multiple transmission channels, the system comprising a machine to machine (M2M) server 100, an M2M device 300, and the M2M access networks 200 comprising a first network 200-a and a second network 200-b as at least two networks for connecting the M2M server 100 and the M2M device 300, the method comprising:
when an O2N communication operation is initiated,
operations S900 and S910 of connecting, by the M2M server 100, a predetermined network, among networks provided in the M2M access networks 200, and transmitting a contact request to the M2M device 300 via the predetermined network;
operation S920 of receiving, by the M2M server 100, a contact acknowledgement from the M2M device 300; and
operations S930 and S940 of providing, by the M2M server 100, service information to the M2M device 300 via the network being connected.
